(19) United States
(12) Patent Application Publication
(10) Pub. No.: US 2011/0188713 A1
(43) Pub. Date: Aug. 4, 2011

(54) FACIAL IMAGE RECOGNITION AND RETRIEVAL

(75) Inventors: Peter Koon Wooi Chin, North Sydney (AU); Trevor Gerald Campbell, North Sydney (AU); Ting Shan, North Sydney (AU)

(73) Assignee: IMPREZZEO PTY LTD, North Sydney NSW (AU)

(21) Appl. No.: 13/054,338

(22) PCT Filed: Jul. 15, 2009
(86) PCT No.: PCT/AU2009/000904

§ 371 Date: Apr. 13, 2011

(30) Foreign Application Priority Data
Jul. 16, 2008 (AU) 2008903639
Feb. 13, 2009 (AU) 2009900639

(51) Int. Cl. G06K 9/00

(52) U.S. Cl. 382/118

(57) ABSTRACT

A method or system providing face verification, including obtaining a set of features from a selected image and determining if there are any faces in the selected image. If faces are determined a dominance factor is assigned to at least one face and verification of an identity of the at least one face in the selected image is attempted and a confidence score returned. In attempting to verify the identity of the at least one face any identity information is extracted from metadata associated with the selected image. Also disclosed is a method of facial image retrieval, including defining a query image set from one or more selected facial images, determining a dissimilarity measurement between at least one query feature and at least one target feature. This enables identification of one or more identified facial images from the target facial image set based on the dissimilarity measurement.

### TECHNICAL FIELD

The present invention generally relates to identification, searching and/or retrieval of digital images. The present invention more particularly relates to Content Based Image Retrieval (CBIR) techniques that incorporate facial information analysis.

### BACKGROUND

Retrieval of images, especially facial images, from a relatively large collection of reference images remains a significant problem. It is generally considered impractical for a user to simply browse a relatively large collection of images, for example thumbnail images, so as to select a desired image. Traditionally, images have been indexed by keyword(s) allowing a user to search the images based on associated keywords, with the results being presented using some form of keyword based relevancy test. Such an approach is fraught with difficulties since keyword selection and allocation generally requires human tagging, which is a time intensive process, and many images can be described by multiple or different keywords.

There is a need for a method, system, computer program product, article and/or computer readable medium of instructions which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF SUMMARY

In a first broad form the present invention provides a form of content based image retrieval that incorporates dynamic facial information analysis.

In a second broad form the present invention seeks to provide for recognition, searching and/or retrieval of images based on analysis of characteristics and content of the images.

In a particular example form, facial information analysis, which may be dynamic, is applied in combination with forms of content based image retrieval. In a further particular example form, the facial information analysis provides a process for obtaining any identifying information in any metadata of the images, and provides methods for locating one or more faces in the images, as well as attempting to verify an identity associated with each face.

In a third broad form the present invention provides a database structure. For example, a database structure to store at least some characteristics of the images, including, for example, facial information and/or other features, such as features obtained from CBIR methods.

In a fourth broad form the present invention provides a method/system for identifying at least one identity of a person shown in an image. In a particular example form this may be achieved by extracting identity information from metadata of an image. Advantageously, the method can reduce the scope of searches required to verify or recognise the identity, thus enhancing the accuracy of recognising the identity against stored identities.

In a fifth broad form, the present invention provides a method/system for locating and retrieving similar images by dynamically analysing the images. Preferably, the method/system only applies facial recognition techniques to images that contain facial characteristics, e.g. a dominance factor for faces and/or a number of faces in the images.

In a particular form there is provided a method of image analysis, combining improvements to known CBIR methods and dynamic facial information analysis. The method extracts a set of features from one or more images. The method provides for face verification, by determining if there are any faces in the selected image(s); and if so, extracting any identification or personality information from metadata associated with the image(s). This can assist to narrow down the search required for face recognition. A dominance factor can be assigned to at least one face, and an attempt can be made to verify the at least one face in the selected image and which returns a confidence score associated with the face

In a further particular form there is provided a method of image retrieval, including: defining a query image set from one or more selected images; dynamically determining a query feature set from the query image set; analysing any facial information; determining a dissimilarity measurement between at least one query feature of the query feature set and at least one target feature of a target set; and, identifying one or more matching images based on the dissimilarity measurement.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates a flowchart showing a method of searching and retrieval of facial images based on the content of the facial images;

FIG. 2 illustrates a functional block diagram of an example processing system that can be utilised to embody or give effect to an example embodiment;

FIG. 3 illustrates a flow chart showing a method for image processing;

FIG. 4 illustrates a flow chart showing a method for categorisation of image search results;

FIG. 5 illustrates a flow chart showing a method for image processing;

FIG. 6 illustrates a flow chart showing a method for identifying a face in an image using a keyword search and automatic face recognition;

FIG. 7 illustrates an overview of a cascade style face detector method;

FIG. 8 illustrates a rotated face in an image requiring alignment.

### PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

In one form there is provided a method of identifying and/or extracting one or more images, preferably facial images, from a ‘target image set’, being one or more target images (i.e. reference images). The method includes constructing a ‘query feature set’ by identifying, determining, calculating or extracting a ‘set of features’ from ‘one or more selected images’ which define a ‘query image set’.

A ‘distance’ or ‘dissimilarity measurement’ is then determined, calculated or constructed between a ‘query feature’ from the query feature set and a ‘target feature’ from the target image set. For example, the dissimilarity measurement may be obtained as a function of the weighted summation of differences or distances between the query features and the target features over all of the target image set. If there are suitable image matches, ‘one or more identified images’ are identified, obtained and/or extracted from the target image set and can be displayed to a user. Identified images may be selected based on the dissimilarity measurement over all query features, for example by selecting images having a minimum dissimilarity measurement.

The weighted summation uses weights in the query feature set. The order of display of identified images can be ranked, for example based on the dissimilarity measurement. The identified images can be displayed in order from least dissimilar by increasing dissimilarity, although other ranking schemes such as size, age, filename, etc. are also possible. The query feature set may be extracted from a query image set having two or more selected images (selected by the user). The query feature set can be identified, determined and/or extracted using a feature tool such as a software program or computer application.

In one form, the query feature set can be extracted using low level structural descriptions of the query image set (i.e. one or more selected images by a user). For example, the query features or the query feature set could be extracted/selected from one or more of: facial feature dimensions; facial feature separations; facial feature sizes; colour; texture; hue; luminance; structure; facial feature position; etc.

The query feature set can be viewed, in one form, as an ‘idealized image’ constructed as a weighted sum of the features (represented as ‘feature vectors’ of a query image). For example, the idealized image could be represented as

$$I = {\sum }_{i} {w}_{i} {x}_{i}$$

where xᵢ is a feature and wᵢ is a weight applied to the feature. The weighted summation uses weights derived from the query image set. A program or software application can be used to construct the query feature set by extracting a set of features from the one or more selected images (i.e. the query image set) and construct the dissimilarity measurement.

An example method seeks to identify and retrieve facial images based on the feature content of the one or more selected images (i.e. the query image set) provided as examples by a user. The query feature set, which the search is based upon, is derived from the one or more example images (i.e. the query image set) supplied or selected by the user. The method extracts a perceptual importance of visual features of images and, in one example, uses a computationally efficient weighted linear dissimilarity measurement or metric that delivers fast and accurate facial image retrieval results.

A query image set Q is a set of example images I typically supplied by a user, so that Q={I_{q1}, I_{q2}, . . . , I_{qQ}}. The set of example selected images may be any number of images, including a single image. A user can provide one, two, three, four, etc. selected images. The user supplied images may be selected directly from a file, document, database and/or may be identified and selected through another image search tool, such as the keyword based Google® Images search tool.

In the following description the target or reference images, sometimes called the image database, is defined as target image set T={Iₘ:m=1, 2, . . . , M}. The query criteria is expressed as a similarity measure S(Q, Iⱼ) between the query Q and a target image Iⱼ in the target image set. A query process Q(Q, S, T) is a mapping of the query image set Q to a permutation Tₚ of the target image set T, according to the similarity function S(Q, where Tₚ={IₘεT: m=1, 2, . . . , M} is a partially ordered set such that S(Q,Iₘ)>S(Q, Iₘ₊₁). In principle, the permutations are that of the whole image database, in practice only the top ranked output images need be evaluated.

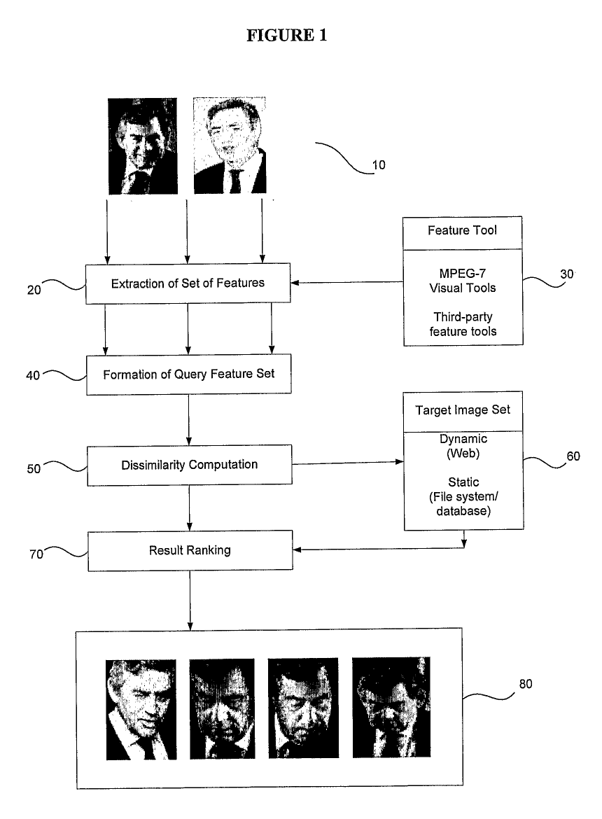

A method of content based facial image retrieval is illustrated in FIG. 1. The method commences with a user selecting one or more selected images to define the query image set 10. The feature extraction process 20 extracts a set of features from the query image set, for example using feature tool 30 which may be any of a range of third party image feature extraction tools, typically in the form of software applications.

A query feature set is then determined or otherwise constructed at step 40 from the extracted set of features. The query feature set can be conceptually thought of as an idealized image constructed to be representative of the one or more selected images forming the query image set. A dissimilarity measurement/computation is applied at step 50 to one or more target images in the target image set 60 to identify/extract one or more selected images 80 that are deemed sufficiently similar or close to the set of features forming the query feature set. The one or more selected images 80 can be ranked at step 70 and displayed to the user.

### Feature Extraction

The feature extraction process 20 is used to base the query feature set on a low level structural description of the query image set. An image object I, for example a facial image, can be described by a set of features X={xₙ: n=1, 2, . . . , N}. Each feature is represented by a kₙ-dimensional vector xₙ={x₁, x₂, . . . , xₖₙ} where x_{n,i}ε|0,b_{n,i}|∪R, and R is a real number. The n^{th} feature extraction is a mapping from image Ito the feature vector as:

xₙ=fₙ(I) (1)

The present invention is not limited to extraction of any particular set of features. A variety of visual features, such as colour, texture, objects, etc. can be used. Third party visual feature extraction tools can be used as part of the method or system to extract features.

For example, the popular MPEG-7 visual tool is suitable. The MPEG-7 Color Layout Descriptor (CLD) is a very compact and resolution-invariant representation of color which is suitable for high-speed image retrieval. MPEG-7 uses only 12 coefficients of 8×8 DCT to describe the content from three sets (six for luminance and three for each chrominance), as expressed as follows:

x_{CLD}=(Y₁, . . . , Y₆,Cb₁,Cb₂,Cb₃,Cr₁Cr₂,Cr₃) (2)

The MPEG-7 Edge Histogram Descriptor (EHD) uses 80 histogram bins to describe the content from 16 sub-images, as expressed as follows:

x_{EHD}=(h₁,h₂, . . . , h₈₀) (3)

While the MPEG-7 set of tools is useful, there is no limitation to this set of feature extraction tools. There are a range of feature extraction tools that can be used to characterize images according to such features as colour, hue, luminance, structure, texture, location, objects, etc.

### Query Feature Set Formation

The query feature set is implied/determinable by the example images selected by the user (i.e. the one or more selected images forming the query image set). A query feature set formation module generates a ‘virtual query image’ as a query feature set that is derived from the user selected image(s). The query feature set is comprised of query features, typically being vectors.

The fusion of features forming a particular image may be represented by:

xⁱ=(x₁ⁱ⊕x₂ⁱ⊕ . . . ⊕xₙⁱ) (4)

For a query image set the fusion of features is:

X=(x¹⊕x²⊕ . . . ⊕x^{m}) (5)

The query feature set formation implies an idealized query image which is constructed by weighting each query feature in the query feature set used in the set of features extraction step. The weight applied to the i^{th} feature x, is:

wᵢ=f_{w}ⁱ(x₁¹,x₂¹, . . . , xₙ¹;x₁²,x₂², . . . , xₙ²; . . . , x₁^{m},x₂^{m}, . . . , xₙ^{m}) (6)

The idealized/virtual query image I_{Q} constructed from the query image set Q can be considered to be the weighted sum of query features xᵢ in the query feature set:

$${I}_{Q} = {\sum }_{i} {w}_{i} {x}_{i} \qquad ( 7 )$$

### Dissimilarity Computation

The feature metric space Xₙ is a bounded closed convex subset of the kₙ-dimensional vector space R^{kn}. Therefore, an average, or interval, of feature vectors is a feature vector in the feature set. This is the base for query point movement and query prototype algorithms. However, an average feature vector may not be a good representative of other feature vectors. For instance, the colour grey may not be a good representative of colours white and black.

In the case of a multi-image query image set, the ‘distance’ or ‘dissimilarity’ is measured or calculated between the query image set Q={I_{q1}, I_{q2}, . . . , I_{qQ}} and a target image IⱼεT as:

D(Q,Iⱼ)=D({I_{q1},I_{q2}, . . . , I_{qQ}},Iⱼ) (8)

In one example, a distance or dissimilarity function expressed as a weighted summation of individual feature distances can be used as follows:

$$D ( {I}_{q} , {I}_{m} ) = {\sum }_{i = 1}^{N} {w}_{i} \cdot {d}_{i} ( {x}_{qi} , {x}_{ni} ) \qquad ( 9 )$$

Equation (9) provides a measurement which is the weighted summation of a distance or dissimilarity metric d between query feature x_{q} and queried target feature xₙ of a target image from the target image set.

The weights w₁ are updated according to the query image set using equation (6). For instance, the user may be seeking to find images of bright coloured cars. Conventional text based searches cannot assist since the query “car” will retrieve all cars of any colour and a search on “bright cars” will only retrieve images which have been described with these keywords, which is unlikely. However, an initial text search on cars will retrieve a range of cars of various types and colours. When the user chooses one or more selected images that are bright the feature extraction and query formation provides greater weight to the luminance feature than, say, colour or texture. On the other hand if the user is looking for blue cars, the one or more selected images chosen by the user would be only blue cars. The query formation would then give greater weight to the feature colour and to the hue of blue rather than to features for luminance or texture.

In each case the dissimilarity computation is determining a similarity value or measurement that is based on the features of the query feature set (as obtained from the query image set selected by the user) without the user being required to define the particular set of features being sought in the target image set. It will be appreciated that this is an advantageous image searching approach.

### Result Ranking

The image(s) extracted from the target image set using the query image set can be conveniently displayed according to a relevancy ranking. There are several ways to rank the one or more identified images that are output or displayed. One possible and convenient way is to use the dissimilarity measurement described above. That is, the least dissimilar (most similar) identified images are displayed first followed by more dissimilar images up to some number of images or dissimilarity limit. Typically, for example, the twenty least dissimilar identified images might be displayed.

The distance between the images of the query image set and a target image in the database is defined as follows, as is usually defined in a metric space:

$$d ( Q , {I}_{j} ) = {min}_{{I}_{q} ∈ Q} \{ d ( {X}_{q} , {X}_{j} ) \} \qquad ( 10 )$$

The measure of d in equation (10) has the advantage that the top ranked identified images should be similar to one of the example images from the query image set, which is highly expected in an image retrieval system, while in the case of previously known prototype queries, the top ranked images should be similar to an image of average features, which is not very similar to any of the user selected example images. The present method should thus provide a better or improved searching experience to the user in most applications.

An example software application implementation of the method can use Java Servlet and JavaServer pages technologies supported by an Apache Tomcat® web application server. The application searches for target images based on image content on the Internet, for example via keyword based commercial image search services like Google® or Yahoo®. The application may be accessed using any web browsers, such as Internet Explorer or Mozilla/Firebox, and uses a process to search images from the Internet. In a first step, a keyword based search is used to retrieve images from the Internet via a text based image search service to form an initial image set.

In a second step, a user selects one or more images from the initial search set to form the query image set. Selected images provide examples that the user intends to search on, this can be achieved in one embodiment by the user clicking image checkboxes presented to the user from the keyword based search results. In a third step, the user conducts a search of all target images in one or more image databases using a query feature set constructed from the query image set. Alternatively, it should be appreciated that the one or more selected images forming the query image set can come from a variety of other image sources, for example a local storage device, web browser cache, software application, document, etc.

According to another example, the method can be integrated into desktop file managers such as Windows Explorer® or Mac OS X Finder®, both of which currently have the capability to browse image files and sort them according to image filenames and other file attributes such as size, file type etc. A typical folder of images is available to a user as a list of thumbnail images. The user can select a number of thumbnail images for constructing the query image set by highlighting or otherwise selecting the images that are closest to a desired image. The user then runs the image retrieval program, which can be conveniently implemented as a web browser plug-in application.

### Facial Recognition

The feature extraction process may also extract facial features such as, for example, facial feature dimensions, facial feature separations, facial feature sizes, colour, texture, hue, luminance, structure, facial feature position, distance between eyes, colour of eyes, colour of skin, width of nose, size of mouth, etc. The process can also include detecting any personalities/identities from the metadata of the images. This provides the possibility of using a set of facial features/images to identify a face/person using a database of target facial images. The identity information from the metadata provides for a more effective and efficient method to verify the identity, by reducing the scope of searches required to verify or recognise the identity, thus enhancing the accuracy of recognising the identity against identities stored in the system. The image retrieval methods based on a set of features described hereinbefore can be utilised at least in part.

According to a particular example, a facial image retrieval method/system makes use of two stages:

‘Image Analysis’ is performed on all facial images stored as part of the system during initialisation. Subsequently, any new images that are added to the system are also analysed. The analysis of each image in the system need only occur once. By analysing facial images and extracting pertinent feature information from each image and storing the information in one or more databases, this can be used to provide a relatively quick and efficient user searching experience;

‘Image Match or Refinement’ is performed on a user selection of one or more facial images, i.e. a query image set. The ‘Image Match or Refinement’ stage can integrate with a user's existing image search methodology to provide for searching of facial images by using a set of one or more images of a face(s) instead of a text or keyword description. The ‘Image Match or Refinement’ stage is carried out by analysing the selected facial image(s) and then retrieving identified facial images from one or more target facial image databases that most closely match extracted features of the one or more selected facial images.

### Facial Image Database Structure

The database structure provides a technical link not only between two distinct technologies, i.e. image retrieval and facial recognition (e.g. facial feature extraction) techniques, but also provides a link between an image analysis phase and an image search phase. The one or more databases have a number of tables including:

1. Facial Image Information

2. Facial Features Information

3. Persons Database

A facial image database(s) contains the sets of features and facial information, such as an associated name or individual's details, of facial images in the system. At the analysis phase, the facial image database is populated by analysing facial images and extracting required relevant features and/or facial information based on the facial images.

The Image Information Table (Table I) includes information on facial images in the system. This information is stored in the database during the initial stage of configuring or setting up the system, i.e. during the loading, uploading, downloading or storing of facial images into the system.

TABLE I
Image Information Table

| Field | Description |
|---|---|
| Image Identifier | An identifier is assigned to each facial image in the |
| | system to uniquely identify the facial image. |
| Location | The location information provides information on the |
| Information | location of thumbnail, preview and actual high quality |
| | images. |
| Batch Identifier | This identifies the batch of images for processing. |
| Batch Status | Batch status is an indicator of the processing status |
| | of a batch of images, for example: |
| | Undergoing Phase 1 Analysis |
| | Phase 1 Analysis Complete |
| | Undergoing Phase 2 Analysis |
| | Phase 2 Analysis Complete |

The Features Information Table (Table II) includes extracted sets of features and facial information of facial images in the system. This information is stored in the database during an image analysis phase. The information in this table then can be used to locate matching facial images.

TABLE II
Features Information Table

| Field | Description |
|---|---|
| Image Identifier | The unique identifier of the image. |
| Feature Data | Series of fields for the features extracted from the |
| | image. |
| Facial | This contains information on the faces detected in the |
| Information | image. |
| Number of faces | Number of faces detected in the image. |

For each detected face

| | |
|---|---|
| Dominance | This indicates the dominance of the face in the image |
| Factor | relative to other detected faces, if any. |
| Person Identifier | A unique person identifier is assigned to every person |
| | registered (i.e. recognised) in the Persons Database. |
| | This is set to −1 (unknown) if the face is not a |
| | recognised person. |
| Confidence Score | The confidence score is derived during the automatic |
| | face recognition phase. |
| | This can be set to 100% if the recognition is done |
| | during the human agent verification stage. |

A Persons Database holds Persons Tables (Table III) for storing information about the people registered (i.e. recognised) in the system. This table is preferably populated during the facial recognition stages. The facial recognition stages can include a separate training stage whereby images of a specific person are analysed to collection facial recognition information for that particular person. The facial recognition data can also come from faces verified during a human agent verification phase (further discussed hereinafter). The information in this table is used during facial recognition and/or verification stages.

TABLE III
Persons Table

| Field | Description |
|---|---|
| Person Identifier | Unique identifier for a person registered in the |
| | system. |
| Name | Name of person. |
| Alias | Variation(s) of name of person. |
| Face Recognition Data | Training data for person used in automatic face |
| | recognition/verification. |

### Image Analysis Methodology

An image analysis process encompasses two phases. A first phase (Phase 1—Automated Image Analysis) is a procedure of providing an automated process to analyse and extract relevant features and information from facial images. A second phase (Phase 2—Human Agent Verification), which is optional, provides for human agent interaction with the system to verify and increase the integrity and accuracy of the data in the system, if required. The second phase can be used to ensure that the data in the system is accurate and reliable.

### Phase 1: Automated Image Analysis

This phase describes the automated processing of images. This is an analysis phase where facial images in the system, preferably but not necessarily all facial images, are processed to extract relevant information from the facial images. The facial images in the system only need be processed once. Bulk processing of images can be performed in batches during the installation and configuration stages of the system. Bulk loading of images can be managed with a software based workbench tool/application. Any new facial images that are added to the system can be made to undergo this processing phase to make sure that the new images are known in the system. An image processor/engine analyses the facial images one at a time. Images may be batched together in groups for processing. A Batch Identifier is assigned to each batch of images. The extracted information is stored in the relevant tables in one or more databases.

Reduction of image features can be useful in processing facial images, for example the feature reduction methods disclosed in International Publication No. WO 2006/063395, which are incorporated herein by reference.

For each image, the image processor/engine preferably performs the following steps:

1. Extract the set of features of the image. The extracted set of features are stored in the Features Information Table.

2. Determine if there are any faces in the image, by passing the image through a face detection component/module application, which can be any type of known face detection application, such as a third party application.

3. For each face detected in the image, assign a Dominance Factor, which is a relative size indicator of the face relative to the other faces in the image. If the number of faces detected is incorrect, the Dominance Factor can be adjusted during a human agent verification phase.

4. If face recognition is enabled in the workbench tool, then proceed to verify the faces detected.

5. A. Retrieve any metadata associated with the image, including image caption and headlines.
B. Provide a User Exit routine to retrieve the metadata attached to the image to cater for different metadata definitions for different users.
C. Determine if there are any names contained within the metadata. The names in the Persons Database may be used as a template for searching for names in the metadata.
D. The algorithm used in determining names in the metadata should cater for the variation of names for the persons, as defined in the Persons Database.

6. A. For each detected face in the image:
B. Attempt to verify/recognise the identity of the face against the list of names extracted from the metadata of the image. This verification procedure invokes the particular Face Recognition technology utilised and verifies the identity of the face using the face recognition data stored in the Persons Database. The application can also cater for names that may not be in the Persons Database by including these names during the human agent verification phase.
C. If there is no metadata associated with the image, or there are no names found in the metadata, or if the face cannot be verified using the extracted names from the metadata, the method can attempt to perform automatic face recognition against all the known persons stored in the Persons Database.

7. Each automatic face verification and face recognition executed preferably returns an associated Confidence Score. This Confidence Score is a rating of how confident the Face Recognition technology is that the facial image matches a particular person from the Persons Database.

8. Any face that cannot be verified or recognised automatically can be marked as ‘Unknown’. This category of faces can be picked up in the human agent verification phase.

There can be provided threshold settings for determining the resulting action for every face verification or recognition procedure. A user can configure these settings by using the workbench tool. The Confidence Score associated with each face verified or recognised can be gauged against these thresholds to determine the course of action as outlined in Table IV below.

TABLE IV
Course of Action

| Threshold | Description |
|---|---|
| Less than | Any face with a Confidence Score below this threshold |
| threshold 1 (T₁) | setting will be ignored, i.e. the face in the image is |
| | marked as ‘Unrecognised’ automatically. |
| Greater than | Any face with a Confidence Score above this threshold |
| threshold 2 (T₂) | setting will be automatically marked as ‘Recognised’. |
| | The associated Confidence Score is stored in the |
| | Features Information table. |
| Between T₁ and | Any face with a Confidence Score between T₁ and T₂ |
| T₂ | can be marked for human agent verification, i.e. this |
| | requires a human agent to manually determine the |
| | identity of the face. |

At the completion of this phase, each face detected in the image is categorised according to its Verification Status, as outlined in Table V below.

TABLE V
Categorisation

| Status | Description |
|---|---|
| Unknown | The face detected in the image is unknown. This |
| | may because the face cannot be verified or |
| | recognised. |
| Unrecognised | The face detected in the image achieved a |
| | Confidence Rating below the T₁ threshold. |
| Recognised State 1 | The face detected in the image achieved a |
| | Confidence Score between the T₁ and T₂ thresholds. |
| Recognised State 2 | The face detected in the image achieved a |
| | Confidence Rating above the T₂ threshold. |

Error handling of face detection can be set to accommodate different error tolerances, for example as acceptable to different types of users, such as a casual user compared to security personnel.

### Phase 2: Human Agent Verification

A second phase of image analysis concerns the ability to provide collating and presenting the results of Phase 1—Automated Image Analysis. This phase is generally only executed against images belonging to a batch that have completed the Phase 1 analysis. Phase 2 is only required if there is a requirement for face recognition, i.e. this phase is not required if a user only requires facial image matching based on the features and the collection of faces in the images.

Preferably phase 2 of the image processor is deployed as a Java application. This application is typically only required during the initialisation period of the system, i.e. during the loading of images, or new images, into the system. The User Interface of this application can provide user-friendly labelling and navigation and preferably can be used by non-technical users.

Preferably, though not necessarily, the application provides at least some of the following functionalities:

1. The face(s) detected in each image processed by Phase 1—Automated Image Analysis are categorised according to their Verification Status as outlined above. Potentially, there are three categories of images as described in Table VI. The images are grouped according to these categories. Each category of images can presented in the application separately.

TABLE VI
Categorisation

| Category | Description |
|---|---|
| Successfully | All faces in the image have been successfully verified |
| Recognised | and/or recognised. |
| | These are images with all their detected faces |
| | classified with the ‘Recognised State 2’ status. |
| Human Agent | An image with any faces with the status of either |
| Verification | ‘Unknown’ or ‘Recognised State 1’ are in |
| Required | this category. This category signifies that human |
| | agent verification is required. |
| Unrecognised | These are images with detected faces classified with the |
| | ‘Unrecognised’ status. |

2. For each of the categories, the user can be allowed to edit the identity associated with any faces detected in the image.

3. The user may be able to correct the actual number of faces in the image. For example, the face detection may only pick up two out of three faces in an image. The user should be able to correct the number of faces as well as provide the identity verification.

4. For each face identified by the user, the Verification Status of that face is changed to ‘Recognised State 1’ and the associated Confidence Score changed to 100%. The associated information for the image (including Person Identifier, Number of Faces, etc.) is also updated.

5. For any faces manually verified or recognised by the human agent, the facial definitions of the face can be stored as additional training data for a recognition algorithm. An image with a new face is flagged for registration in the Persons Database. The registration can be done with the Face Recognition application that provides the functionality to enrol new persons in the Persons Database. A similar functionality also can be provided for any new persons identified by the human agent. A new entry is created in the Persons Database.

As an optional function, once an image has been verified by a human agent, there is an option to apply a similarity search on the associated batch of images to find images that match the verified (reference) image. This may be to provide the user with the ability to verify a number of images simultaneously, especially if the batch contains images from the same event. The user can be provided with the ability to select the images that contain the same face.

### Initial Image Searching

Preferably, the applications hereinbefore described need not totally replace a user's existing search methodology. Rather, the system/method complements an existing search methodology by providing an image refinement or matching capability. This means that there is no major revamp of a user's methodology, especially in a user interface. By provision as a complementary technology, enhancement of a user's searching experience is sought.

A user's existing search application can be used to specify image requirements. Traditionally, users are comfortable with providing a text description for an initial image search. Once a textual description of the desired image is entered by the user, the user's existing search methodology can be executed to provide an initial list of images that best match the textual description. This is considered an original or initial result set.

These original result set images are displayed using a user's existing result display interface. Modifications to the existing results display interface can include the ability for the user to select one or more images as the reference images for refining their image search, i.e. using images to find matching images. Preferably, there is provided functionality in the results display interface (e.g. application GUI) for the user to specify that he/she wants to refine the image search, i.e. inclusion of a ‘Refine Search’ option. Potentially, this could be an additional ‘Refine Search’ button on the results display interface.

When a form of ‘Refine Search’ option is selected, the user's search methodology invokes the image retrieval system to handle the request. The selected images are used as the one or more selected images defining a query image set for performing similarity matches. If required, the search can be configured to search through a complete database to define a new result set. For face detection, the system finds images that contain a similar number of faces as the reference image(s) and/or images that contain the same persons as the reference image(s). If the user is only interested in searching for images of a specific named person, the system can directly perform a keyword name search based on the information in the Persons Database.

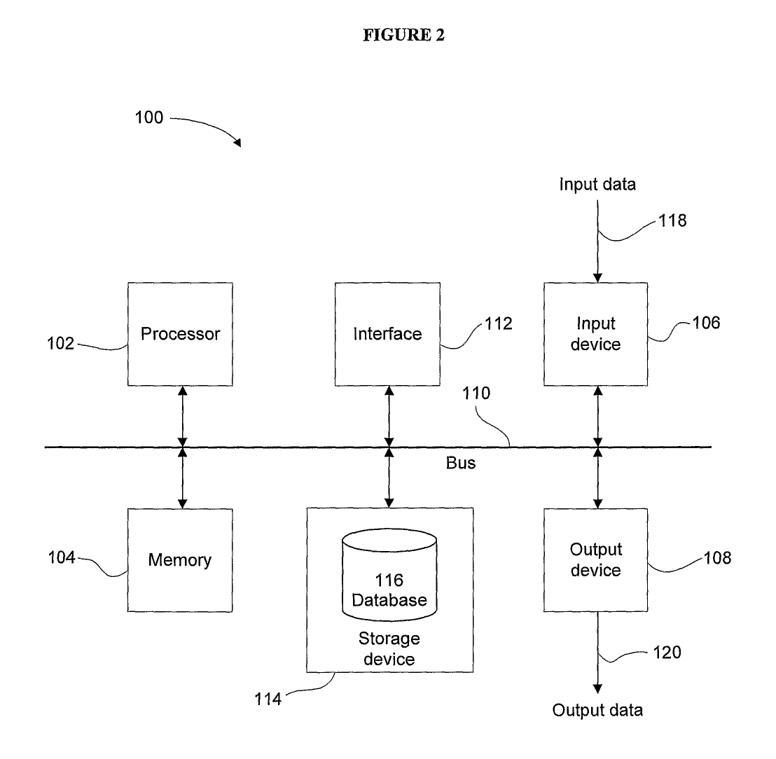

A particular embodiment of the present invention can be realised using a processing system, an example of which is shown in FIG. 2. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, PC, laptop, notebook, PDA, mobile telephone, specialised hardware, or the like.

### Further Example

The following example provides a more detailed discussion of a particular embodiment. The example is intended to be merely illustrative and not limiting to the scope of the present invention.

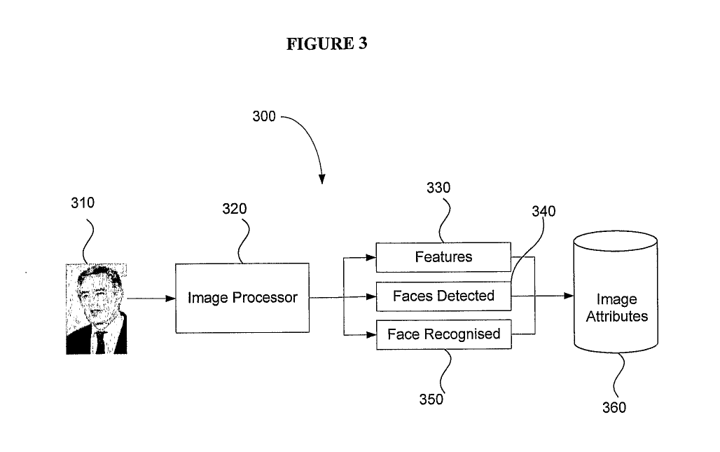

Referring to FIG. 3, there is illustrated a flow chart showing a method 300 for facial image processing. Facial image 310 is submitted to image processor 320 that generates or determines features 330 from image 310 as hereinbefore described. Image processor 320 also determines if any faces are actually detected at step 340. At step 350 image processor 320 determines if the face in image 310 is recognised by using known facial recognition technology. Data/information can be stored in and/or retrieved from image attributes database 360.

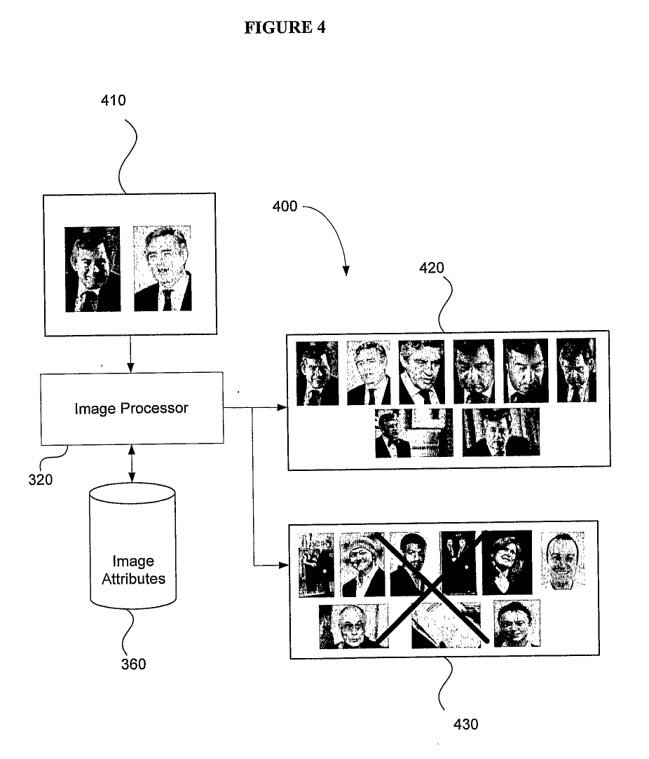

Referring to FIG. 4, there is illustrated a method 400 for facial image search results categorisation. One or more images are selected by a user as query image set 410. One or more selected images 410 are processed by image processor/engine 320 in communication with image attributes database 360. Based on the results of processing against a target image set, identified images that most closely match the images 410 are ranked highly as more relevant identified images 420. Images that do not closely match images 410 are ranked more lowly as set of images 430 are may not be displayed to a user.

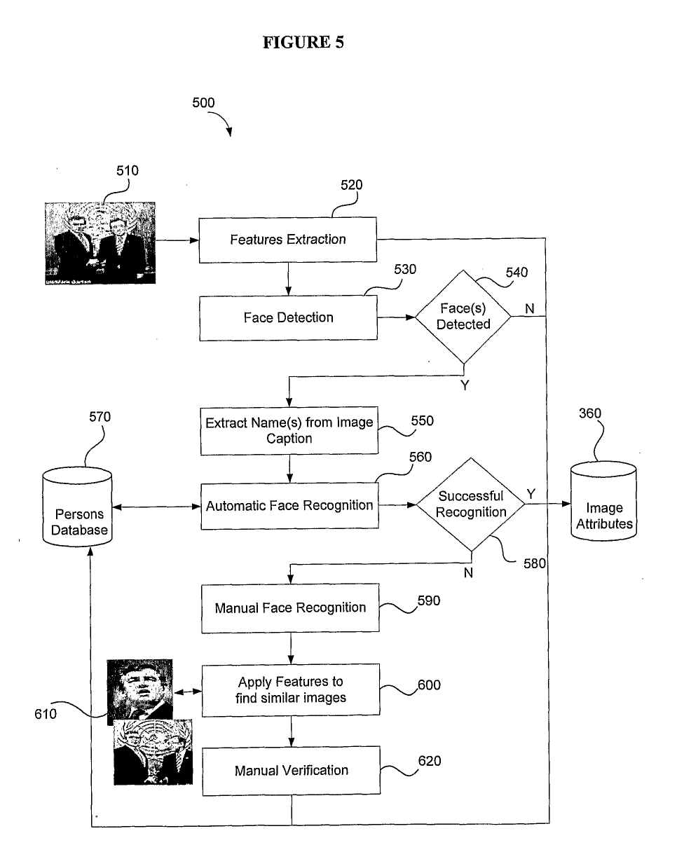

Referring to FIG. 5, there is illustrated a method 500 for facial image recognition, searching and verification. Initial image 510 is processed at step 520 to extract features (i.e. a set of features) and to store the image 510 and/or features in image attributes database 360. At step 530, image 510 is analysed to determine if there are any faces present in the image 510. At step 540, if one or more faces are detected in the image 510 then a search can be made for any names in the metadata of image 510 at step 550. At step 560, any faces detected in the image 510 are sought to be verified against faces/names found using information from the persons database 570 and/or image attributes database 360. This can be achieved using known existing facial recognition software. A confidence threshold can be set whereby images that achieve a confidence score greater than a particular threshold are marked as successfully recognised. If all the detected faces in the image 510 are successfully automatically recognised the facial attributes are stored in image attributes database 360.

At step 580, for any face in the image 510 that cannot be verified automatically (and sufficiently confidently), the image 510 is marked for human agent verification at step 590. Once the faces are manually verified by a human agent at step 590 the details can then be stored in the image attributes database 360. A verified face also can be stored in the persons database 570 either as a new person or as additional searching algorithm training data for an existing person in the database.

Step 600 can be invoked (not necessarily after manual face recognition) to apply the image retrieval process to search a batch of images 610 to look for matching images/faces, and optionally present the results to a human agent to verify if the same face(s) have been detected in batch of images 610 as for image 510. This can provide a form of manual verification at step 620.

### Further Embodiments

### Searching by Keyword and Automatic Face Recognition

The following further embodiments are provided by way of example. In this section there is described a method/system which integrates a traditional keyword search with automatic face recognition techniques. For example, preferably applied to news images. The method/system involves a keyword searching step, which queries images by an identity's names and/or alias, and a verification step, which verifies the identities of faces in images using automatic face recognition techniques.

As previously discussed, retrieval of images, especially facial images, from a large collection of reference images was a significant problem. Traditionally, images have been indexed by keywords allowing users to search the images based on associated keywords, with the results being presented using some form of keywords based relevancy test. Keywords contain a significant amount of information, but one significant problem is that keyword tagging might not be accurate and images are often “over tagged”. With the ongoing development of modern computer vision techniques, systems have been proposed to search news images using face recognition techniques without keywords. However, many problems persist for automatic face recognition using news images before the capability of the human perception is achieved. Face recognition on passport-quality photos has achieved satisfying results, but automatic face recognition based on lower-quality or more variable news images is more challenging. This is not just due to the gross similarity of human faces, but also because of significant differences between face images of the same person due to, for example, variations in lighting conditions, expression and pose. This directly leads to inaccuracy in image searching results.

Keywords can contain important information that could be utilised, and more importantly, many images in most large image collections have already been tagged by keyword(s). An identity search method/system which integrates a keyword search with automatic facial recognition is now described. Images are firstly searched based on keyword(s) and then verified using a face recognition technique.

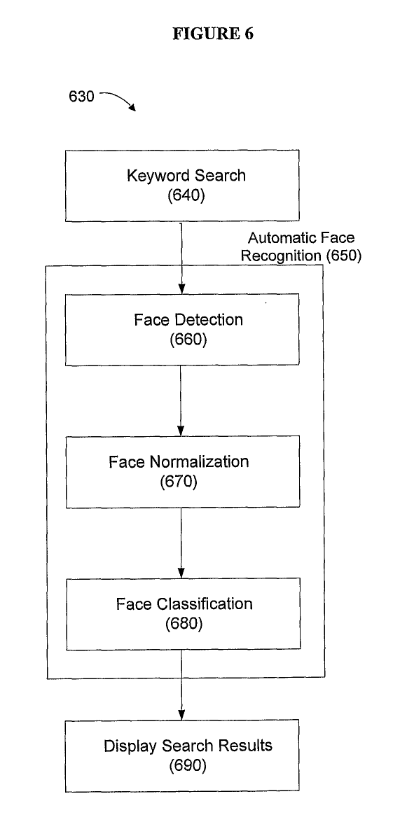

Referring to FIG. 6, there is illustrated an overview of the method/system 630 for automatic face recognition which integrates a keyword search 640 with automatic facial recognition 650.

Keyword search 640: keyword(s) are used to search based on an images' captioning or metadata.

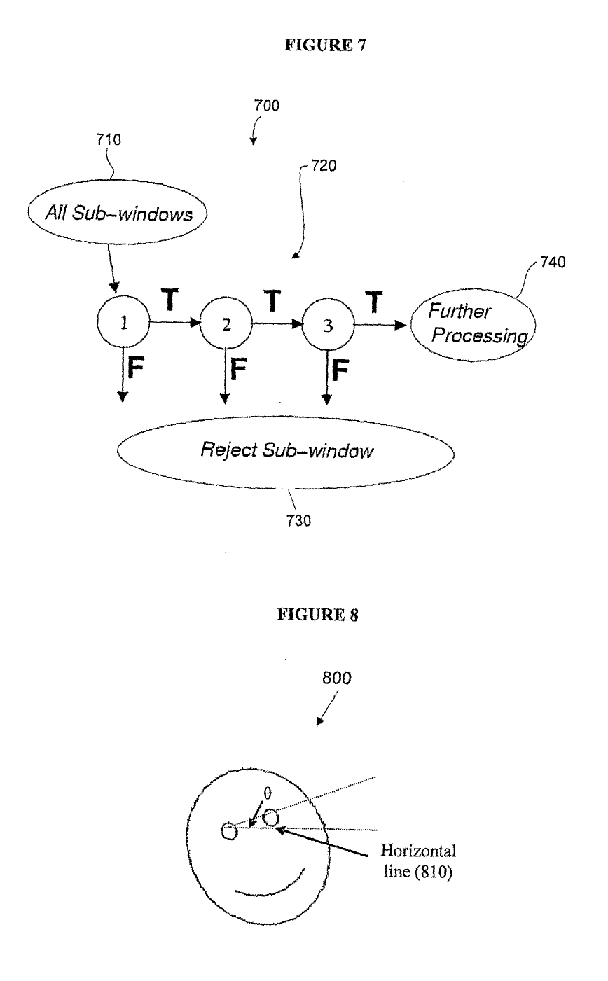

Face Detection 660: an image based face detection system is then used. For example, “Viola, P. and M Jones (2001), Rapid object detection using a boosted cascade of simple features, IEEE Computer Society Conference on Computer Vision and Pattern Recognition, 2001, CVPR 2001”, incorporated herein by reference, disclose a method for good performance in real-time. Referring to FIG. 7, this method 700 combines weak classifiers 720 based on simple binary features, operating on sub-windows 710, which can be computed extremely fast. Simple rectangular Haar-like features are extracted; face and non-face classification is performed using a cascade of successively more complex classifiers 720 which discards 730 non-face regions and only sends face-like candidates to the next layer's classifier for further processing 740. Each layer's classifier 720 is trained by a learning algorithm. As presently applied, the cascaded face detector finds the location of a human face in an input image and provides a good starting point for subsequent searches which then precisely mark or identify major facial features. A face training database is used, that preferably includes a large number of hand labelled faces, which contain face images taken under various lighting conditions, facial expressions and pose angle presentation. Negative training data images can be randomly collected and do not contain human faces.

Face Normalization 670: involves facial feature extraction, face alignment and preprocessing steps.

Facial Feature Extraction: in a particular example can use the method of “Cootes, T. F., C. J. Taylor, et al. (1995), Active Shape Models—Their Training and Application, Computer Vision and Image Understanding 61(1): 38-59”, incorporated herein by reference. Active Shape Models provide a tool to describe deformable object images. Given a collection of training images for a certain object class where the feature points have been manually marked, a shape can be represented by applying PCA to the sample shape distributions as:

X= X̅+Φb (11)

where X̅ is the mean shape vector, Φ is the covariance matrices describing the shape variations learned from the training sets, and b is a vector of shape parameters. Fitting a given novel face image to a statistical face model is an iterative process, where each facial feature point (for example in the present system 68 points are used) is adjusted by searching for a best-fit neighbouring point along each feature point.

Face Alignment: referring to FIG. 8, after the eyes have been located in a face region 800, the coordinates (x_{left}, y_{left}), (x_{right}, x_{right}) of the eyes are used to calculate the rotation angle θ from a horizontal line 810 by:

$$θ = arctan ( \frac{{y}_{right} - {y}_{left}}{{x}_{right} - {x}_{right}} ) \qquad ( 12 )$$

The face image can then be rotated to become a vertical frontal face image.

Preprocessing: the detected face is preprocessed according to the extracted facial features. By way of example only this may include:
1. Converting 256 grey scale values into floating point values;
2. Using eye locations, cropping the image with an elliptical mask which only removes the background from a face, and rescale the face region;
3. Equalizing the histogram of the masked face region; and,
4. Normalizing the pixels inside of the face region so that the pixel values have a zero mean a standard deviation of one.

Face Classification 680: can use Support Vector Machines (SVM) which use a pattern recognition approach that tries to find a decision hyperplane which maximizes the margin between two classes. The hyperplane is determined from the solution of solving the quadratic programming problem:

$${min}_{w , b , ζ} \frac{1}{2} {w}^{T} w + C {\sum }_{i = 1}^{N} {ζ}_{i} \qquad ( 13 )$$

subject to yᵢ(w^{T}Φ(xᵢ)+b)≧1−ζᵢ,ζᵢ≧0.

K(xᵢ,xⱼ) is called a kernel function, four basic kernel functions are used:

Linear: K(xᵢ,xⱼ)=xᵢ^{T}xⱼ

Polynomial: K(xᵢ,xⱼ)=(γxᵢ^{T}xⱼ+r)^{d},γ>0

Radial Basis Function (RBF): K(xᵢ,xⱼ)=exp(−γ∥xᵢ−xⱼ∥²),γ>0

Sigmoid: K(xᵢ,xⱼ)=tan h(γxᵢ^{T}xⱼ+r)

The output of SVM training is a set of labelled vectors xᵢ, which are called support vectors, associated labels yᵢ, weights αᵢ and a scalar b. The classification of a given vector x can be determined by:

$$f ( x ) = {\sum }_{i = 1}^{r} {α}_{i} {y}_{i} K ( x , {x}_{i} ) + b \qquad ( 14 )$$

This method and system thus describes an integrated traditional keyword search and automatic face recognition techniques, for example that can be applied to news-type images. Two main steps are utilised: a keyword searching step which queries images by an identity's name and/or alias, and a verification step which verifies the identity by using automatic face recognition techniques.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

The present invention may take the form of an entirely hardware embodiment, an entirely software embodiment, firmware, or an embodiment combining software and hardware aspects.

1. A method of face verification using at least one processing system, including:
obtaining a set of features from a selected image;
determining if there are any faces in the selected image, and if so assigning a dominance factor to at least one face; and,
attempting to verify an identity of the at least one face in the selected image and returning a confidence score.

2. The method as claimed in claim 1, wherein attempting to verify the identity of the at least one face includes extracting any identity information from metadata associated with the selected image.

3. The method as claimed in claim 2, wherein the identity information is used to reduce a target image set to target images having similar identity information, and verification is performed using the reduced target image set.

4. The method as claimed in any one of the claims 1 to 3, wherein the dominance factor and the confidence score are stored in a database and are associated with a unique person identifier.

5. The method as claimed in any one of the claims 1 to 4, wherein a dominance factor and a confidence score are assigned to each face determined in the selected image.

6. The method as claimed in claim 4, wherein the unique person identifier and a person's name are stored in the database as associated.

7. The method as claimed in any one of the claims 1 to 6, wherein:
if the confidence score is less than a lower threshold, the selected image is stored as unrecognised;
if the confidence score is greater than a higher threshold, the selected image is stored as recognised; or,
if the confidence score is between the lower threshold and the higher threshold, the selected image is tagged for human verification.

8. The method as claimed in any one of the claims 1 to 7, wherein a feature from the set of features is selected from the group consisting of facial feature dimensions, facial feature separations, facial feature sizes, facial feature position, distance between eyes, colour of eyes, colour of skin, width of nose, and size of mouth.

9. A method of facial image retrieval, including:
defining a query image set from one or more selected facial images;
determining a query feature set from the query image set;
determining a dissimilarity measurement between at least one query feature of the query feature set and at least one target feature of a target facial image set; and,
identifying one or more identified facial images from the target facial image set based on the dissimilarity measurement.

10. The method as claimed in claim 9, wherein the at least one query feature is selected from the group consisting of facial feature dimensions, facial feature separations, facial feature sizes, facial feature position, distance between eyes, colour of eyes, colour of skin, width of nose, and size of mouth.

11. The method as claimed in claim 9, wherein the dissimilarity measurement uses a weighted summation of feature distances.

12. The method as claimed in any one of the claims 9 to 11, wherein the one or more identified facial images are displayed to a user in a ranking order dependant on the dissimilarity measurement.

13. The method as claimed in any one of the claims 9 to 12, wherein the query image set is obtained from two or more selected facial images.

14. A computer program product for facial image retrieval, adapted to:
define a query image set from one or more user selected facial images;
determine a query feature set from the query image set;
determine a dissimilarity measurement between at least one query feature of the query feature set and at least one target feature of a target facial image set; and,
identify one or more identified facial images from the target facial image set based on the dissimilarity measurement.

15. The computer program product as claimed in claim 14, wherein a user can select a plurality of thumbnail images to define the query image set.

16. The computer program product as claimed in claim 14, being a web based application or a desktop application.
